(19) United States
(12) Patent Application Publication
(10) Pub. No.: US 2008/0288267 A1
(43) Pub. Date: Nov. 20, 2008

(54) Method and apparatus for automatically managing work tickets

(76) Inventors: Michael Asher, Green Cove Springs, FL (US); Maryna Liublinska, Brookline, MA (US); Harold Stewart, Cumming, GA (US)

Correspondence Address: AT&T CORP., ROOM 2A207, ONE AT&T WAY, BEDMINSTER, NJ, 07921, US

(21) Appl. No.: 11/803,283

(22) Filed: May 14, 2007

(51) Int. Cl. G06Q 10/00

(52) U.S. Cl. 705/1

(57) ABSTRACT

Disclosed is an Interactive Voice Response (IVR) system that automatically manages work tickets. The IVR system receives a work ticket (e.g., a dig ticket) from a Call Center. The work ticket corresponds to work to be performed by a contractor. The IVR system transmits a notification of the work ticket to a technician. The IVR system then receives a response to the notification from the technician. The IVR system then transmits the response to the contractor and/or Call Center.

### BACKGROUND OF THE INVENTION

The present invention relates generally to work tickets and more specifically to automatically managing work tickets.

Telecommunications and utility companies (“carriers”) often own or maintain underground assets, including communications cables, power service cables, water pipes, gas pipes, sewers and other assets. The carriers responsible for those underground assets require anyone digging in the vicinity of the underground assets to first notify (e.g., call) the carriers of the planned excavation. Call Centers have been created to centrally receive these notifications (e.g., calls) and to alert all carriers with underground assets in the vicinity of the planned excavation.

Excavation may occur due to new building construction, boring, maintenance, or installation activities for carriers. Excavation is typically performed by contractors. A carrier representative, or technician, is often sent to the dig site in order to “stake out” the actual location of the underground asset, so contractors may avoid it.

As notifications of planned excavations are received by Call Centers, “work tickets” (such as dig tickets) are created for tracking the status of each notification as it is handled by a carrier. The ticket is typically a record in a database containing information such as an identification of the contractor that will be performing the planned work, a date the notification was received, a planned start date for the work, and a location of the work. Although described herein as a planned excavation and a dig ticket, the work ticket can be any ticket associated with planned work. Because the initial notification may come from a variety of sources (for example, road or building construction companies, utilities, landscapers, farmers and individuals planning to dig in the yard), information about the location of the work may be received in a variety of forms. For example, the information may be a simple description of the work being “near” a landmark such as a building, it may be an address, or the information may be in the form of precise coordinates of the work.

The locations of components of the buried asset are known to the responsible carriers. For example, a carrier responsible for a fiber optic cable system maintains a database of buffer zones surrounding buried cables in the system. When a location of a proposed excavation falls within a buffer zone, it is carefully reviewed and any necessary actions are taken to avoid harming the underground asset.

A large carrier may receive 15,000 to 20,000 work tickets on an average day from 50 different Call Centers throughout the United States. Some of those tickets are closed automatically by the carrier if the dig location is not within an asset buffer zone. In other cases, technicians receive the appropriate work tickets for which they are responsible, and work on those tickets to protect the asset(s). For example, the technician may be present during the excavation, or may mark the area to show where the underground cable is buried.

Sometimes, however, a cable cut happens for various reasons. In one example, a contractor may have failed to inform the Call Center about the planned excavation. In that case, the carrier does not receive notification and, as a result, would not have created a work ticket. In another example, a technician may be unable to be present at the dig location because there was insufficient notice of the dig alert, or because the contractor dug earlier than the date contained in the work ticket. In yet another example, the contractor may have dug in a location other than that described in the work ticket.

In any event, if damage to an underground asset such as a cable cut occurs, carrier personnel must find the work ticket, if any, that was issued for the particular excavation that caused the damage. The ticket is necessary to quickly identify the contractor and to determine when the ticket was received by the carrier, what the dig location coordinates were, etc. That is necessary in order to prevent further damage by the contractor, to quickly detect problems in the carrier's systems or procedures used to handle work tickets, and, if necessary, to seek compensation from the contractor.

Delivery of “short-notice” tickets, or tickets that require action within a short time frame, may also be followed by some notification process to alert the responsible technicians that immediate action is required. Notification may be via a beeper or an automated or manual telephone call, and will typically direct the technician to “log in” to a central system to receive their tickets. In extremely time-critical situations, a technician may be asked to directly call the contractor identified on the ticket, to receive ticket details directly from the contractor, and to inform the contractor as to whether buried assets are at risk from the excavation.

A special class of short-notice tickets are emergency tickets—those tickets where the excavation is required to protect against immediate risk to life or property damage. In such cases, the contractor is not required to provide any advance notice. As a result, by the time the carrier receives an emergency ticket, the excavation is likely already in progress and underground assets are already at risk. Furthermore, quite often such tickets are received outside normal business hours, where notification of a technician is problematic. A carrier may therefore not be handling work tickets such as short-notice or emergency work tickets efficiently.

As described above, a large number of steps are typically performed by (and often legally required from) a carrier once a work ticket is received. These steps and the time needed to perform each step often make handling work tickets burdensome and inefficient for the carrier. There still remains a need to more efficiently handle work tickets, including short-notice or emergency work tickets.

### BRIEF SUMMARY OF THE INVENTION

The present invention enables more efficient management of work tickets.

In accordance with an embodiment of the present invention, an Interactive Voice Response (IVR) system automatically manages work tickets such as dig tickets. The IVR system may receive a work ticket from a Call Center. The work ticket corresponds to work to be performed by a contractor in the future. The IVR system transmits a notification of the work ticket to a technician associated with a carrier. For example, the IVR system calls a carrier technician. The IVR system then receives a response to the notification from the technician. The IVR system then transmits the response to the contractor (and/or the Call Center).

In one embodiment, the IVR system performs text-to-speech conversion of one or more details of the work ticket. The IVR system transmits the output of the text-to-speech conversion to the technician. The one or more details of the work ticket may include a ticket address, driving directions to the ticket address from a stored address for the technician, a mode of excavation, ticket remarks, etc.

The response may be, for example, selected from a plurality of preprogrammed responses and/or the response may include a recording. In one embodiment, the IVR system enables the contractor and the technician to communicate with each other.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system having an Interactive Voice Response (IVR) system to automatically manage work tickets in accordance with an embodiment of the present invention;

FIG. 2 is a flowchart illustrating the steps performed by the IVR system of FIG. 1 in accordance with an embodiment of the present invention; and

FIG. 3 shows a high level block diagram of a computer system which may be used in an embodiment of the invention.

### DETAILED DESCRIPTION

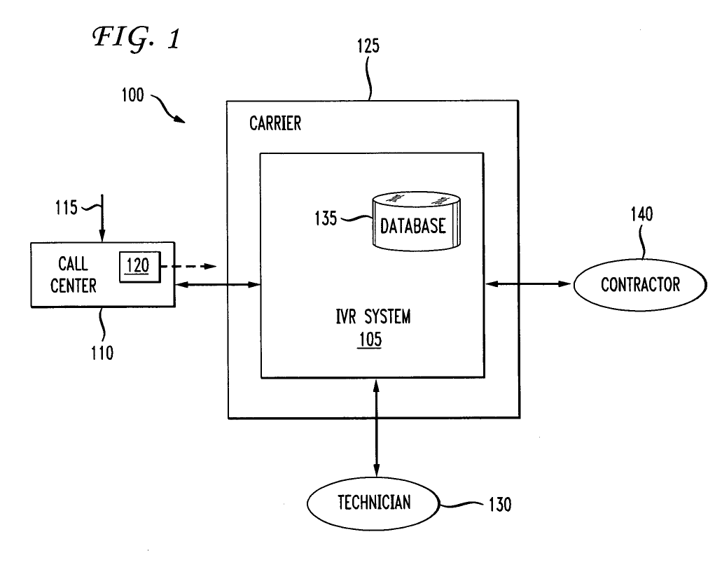

FIG. 1 is a block diagram of a system 100 having an Interactive Voice Response (IVR) system 105 to automatically manage work tickets. As described above, a contractor who plans on digging near an underground asset contacts a Call Center 110 via contact 115. The contact 115 may be a telephone call to the Call Center 110. The contact 115 may alternatively be an email, a text message, a letter, or any other means of communication to the Call Center 110. Further, although illustrated with a single Call Center 110, the system 100 may include any number of Call Centers 110.

In response to the received contact 115, the Call Center 110 generates a work ticket 120 for that contact 115. A work ticket is a record in a database and represents a unit of work. In one embodiment, each work ticket has fields corresponding to information received from the contact 115. This information may include the name of the caller, the date and time of the call, the location or address of the planned excavation (i.e., the ticket address), mode of excavation (e.g., boring, trenching, digging, etc.), the time of the planned excavation, and/or remarks (e.g., left by the caller or inputted into the work ticket). The remarks may be a classification of the ticket, such as that the ticket is a short-notice ticket or an emergency ticket.

The Call Center 110 transmits the work ticket 120 to carriers with underground assets in the vicinity of the planned excavation, such as carrier 125. In accordance with an embodiment of the present invention, the work ticket 120 is transmitted to the IVR system 105 of carrier 125.

The IVR system 105 provides an automated technique to analyze and manage the work ticket 120. The IVR system 105 notifies a particular technician 130 that the work ticket 120 has been received. The IVR system 105 may also provide work ticket information to the technician. The technician 130 is, for example, an individual who is responsible for the underground assets within the area of the planned excavation identified in the work ticket. The technician 130 may also be an individual that can make a decision as to the underground asset within the area of the planned excavation. The IVR system 105 may notify the technician 130 in any of a variety of ways. For example, the IVR system 105 may call the technician via telephone, may email the technician, may contact the technician via facsimile, may contact the technician via the technician's beeper, etc. In one embodiment, the IVR system 105 includes a database 135 which stores one or more numbers or addresses (e.g., email addresses) that can be used to contact technicians such as technician 130.

The IVR system 105 then receives a response from the technician 130. The response is a communication to be delivered to the Call Center 110 and/or contractor 140. The response may include instructions that the contractor 140 can proceed with digging in the requested location or instructions that the contractor 140 cannot proceed with digging in the requested location. The response may also include instructions that the contractor 140 needs to wait until the technician 130 shows up at the proposed dig site before the excavating begins.

In one embodiment, using the telephone keypad or voice recognition technology, the technician chooses from a list of preprogrammed responses. The technician 130 may alternatively or additionally choose to record a message as part of the technician's response.

In one embodiment, upon receipt of the technician's response, the IVR system 105 contacts (e.g., places a separate call to) the contractor 140. The IVR system 105 delivers the technician's response to the contractor 140. Thus, the technician does not have to independently determine how to contact the particular contractor planning to perform the excavation. As a result, the contractor will likely receive the technician's response in a timely manner.

In one embodiment, the IVR system 105 also transmits the response to the Call Center 110. The Call Center 110 may “close” a work ticket (e.g., erase the work ticket or store the work ticket in a separate database) after receiving notification from the carrier that a response to the work ticket has been communicated to the contractor.

Thus, the IVR system 105 handles work tickets in an automated fashion. Once a work ticket is received, the IVR system 105 calls the technician 130 so the technician can investigate the work ticket, provides the technician 130 with information about the work ticket, receives a response from the technician 130, and communicates the response to the contractor 140 and/or the Call Center 110.

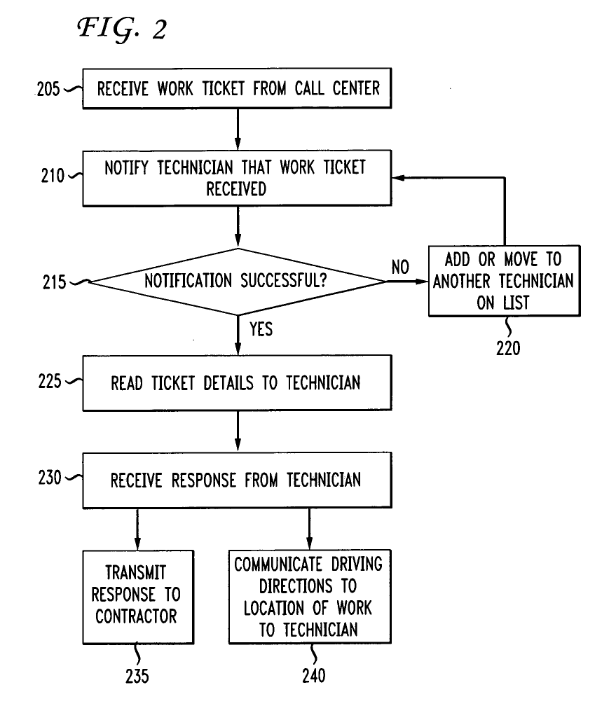

FIG. 2 shows a flowchart illustrating the steps performed by the IVR system 105 in accordance with an embodiment of the present invention. As described above, the IVR system 105 receives a work ticket from the Call Center 110 in step 205. The Call Center 110 may first screen work tickets generated from contacts 115 before transmitting particular work tickets 120 to the IVR system 105. For example, if a contact 115 is received detailing an excavation that will not take place for two years, the Call Center 110 may not send the corresponding work ticket to the IVR system 105 until a later date because of the delay before the planned excavation. This screening may take place automatically (by a computer) or manually (by a human being).

The IVR system 105 then notifies a carrier technician 130 that the work ticket has been received in step 210. In one embodiment, the IVR system 105 retrieves from database 135 the contact information for a technician that handles an area that contains the location of the excavation detailed in the work ticket. The IVR system 105 may also retrieve a list of technicians that the IVR system 105 then attempts to contact. The IVR system 105 may contact technicians on the list in a particular order or may randomly contact technicians on the list. In one embodiment, the list catalogs technicians in order of their position (i.e., their title, rank or superiority) at the carrier, and the IVR system 105 contacts the technicians on the list in ascending or descending order. For example, a first technician on the list may be a lead engineer and a second technician on the list may be a manager of lead engineers including the first technician. If the first technician (lead engineer) is not reachable (and the notification is therefore unsuccessful in step 215), the next technician on the list may be the second technician (manager of lead engineers). The IVR system 105 may attempt to reach the first technician (lead engineer) until a predetermined time period elapses, at which point the IVR system 105 may then add (or move to) another technician (e.g., the second technician) on the list in step 220. The IVR system 105 then returns to step 210 and attempts to notify the second technician (manager of lead engineers) on the list that the work ticket has been received.

In other embodiments, such as when the time frame required to respond to the work ticket is small (e.g., an emergency work ticket) or when the underground assets are extremely important, the IVR system 105 may attempt to contact multiple technicians on the list in parallel (i.e., simultaneously) to increase the probability that the work ticket is responded to in a timely fashion.

Once a technician 130 has been notified via a telephone call in step 215, the IVR system 105 uses text-to-speech technology to read ticket details to the technician 130 in step 225. Ticket details can include, for example, the ticket address (i.e., the address of the planned excavation), the time of the planned excavation, mode of excavation, ticket remarks, etc. Thus, the technician 130 does not need to access an external system to obtain this information and does not need to call a central office to have ticket details manually read to the technician 130.

The IVR system 105 then waits for a response to the ticket from the technician 130. The IVR system 105 receives a response in step 230. As described above, the response may be chosen from a list of preprogrammed responses and/or may be a message recorded by the technician. The IVR system 105 then transmits the response to the contractor 140 in step 235. In one embodiment, the technician 130 instructs the IVR system 105 to simultaneously contact the contractor 140 (i.e., conference in the contractor). The IVR system 105 may then use a separate telephone line to call the contractor 140 and then put the technician 130 in direct contact with the contractor 140 by bridging the voice signal between the two calls. Thus, the IVR system 105 connects the contractor 140 with the technician 130.

In one embodiment, the IVR system 105 may communicate driving directions to the location of the work (e.g., dig) to the technician 130 in step 240. Step 240 may occur simultaneous with step 235 or may occur before or after step 235 has been performed. The IVR system 105 may provide these driving directions using geographic information system (GIS) functionality along with text-to-speech technology. Directions may be provided from an address (stored in the IVR system's database) of the telephone number that the IVR system 105 successfully contacted in step 215. Thus, a technician 130 called at home will be read different directions than the same technician called at work or a different technician called at home. Although a technician who regularly investigates particular work tickets in the same general area may not find the directions particularly useful, this embodiment may be useful when a backup or alternate technician is assigned to investigate a work ticket in an unknown area.

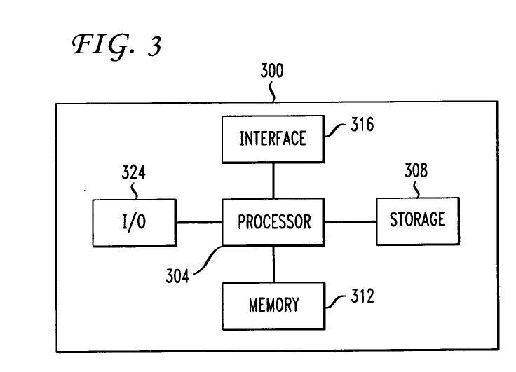

The previous description describes the present invention in terms of the processing steps required to implement an embodiment of the invention. These steps may be performed by an appropriately programmed computer, the configuration of which is well known in the art. An appropriate computer may be implemented, for example, using well known computer processors, memory units, storage devices, computer software, and other nodes. A high level block diagram of such a computer is shown in FIG. 3. Computer 300 contains a processor 304 which controls the overall operation of computer 300 by executing computer program instructions which define such operation. The computer program instructions may be stored in a storage device 308 (e.g., magnetic disk) and loaded into memory 312 when execution of the computer program instructions is desired. Computer 300 also includes one or more interfaces 316 for communicating with other devices (e.g., locally or via a network). Computer 300 also includes input/output 324 which represents devices which allow for user interaction with the computer 300 (e.g., display, keyboard, mouse, speakers, buttons, etc.). In one embodiment, computer 300 represents the IVR system 105.

One skilled in the art will recognize that an implementation of an actual computer will contain other nodes as well, and that FIG. 3 is a high level representation of some of the nodes of such a computer for illustrative purposes. In addition, one skilled in the art will recognize that the processing steps described herein may also be implemented using dedicated hardware, the circuitry of which is configured specifically for implementing such processing steps. Alternatively, the processing steps may be implemented using various combinations of hardware and software.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operation of an Interactive Voice Response (IVR) system comprising:
receiving a work ticket corresponding to work to be performed by a contractor;
transmitting a notification of said work ticket to a technician;
receiving a response to said notification from said technician; and
transmitting said response to said contractor.

2. The method of claim 1 wherein said transmitting a notification further comprises performing text-to-speech conversion of at least one detail of said work ticket and transmitting the output of said text-to-speech conversion to said technician.

3. The method of claim 2 wherein said at least one detail comprises a ticket address.

4. The method of claim 3 wherein said at least one detail comprises driving directions to said ticket address from a stored address for said technician.

5. The method of claim 2 wherein said at least one detail comprises a mode of excavation.

6. The method of claim 2 wherein said at least one detail comprises ticket remarks.

7. The method of claim 1 wherein said response is at least one of a preprogrammed response and a recording.

8. The method of claim 1 further comprising connecting said contractor with said technician.

9. The method of claim 1 wherein said transmitting a notification further comprises transmitting a notification to a plurality of technicians in a predetermined order.

10. The method of claim 1 wherein said work ticket is a dig ticket.

11. An Interactive Voice Response (IVR) system comprising:
means for receiving a work ticket corresponding to work to be performed by a contractor;
means for transmitting a notification of said work ticket to a technician;
means for receiving a response to said notification from said technician; and
means for transmitting said response to said contractor.

12. The IVR system of claim 11 wherein said means for transmitting a notification of said work ticket further comprises means for performing text-to-speech conversion of at least one detail of said work ticket and means for transmitting the output of said text-to-speech conversion to said technician.

13. The IVR system of claim 12 wherein said at least one detail comprises a ticket address.

14. The IVR system of claim 13 wherein said at least one detail comprises driving directions to said ticket address from a stored address for said technician.

15. The IVR system of claim 12 wherein said at least one detail comprises a mode of excavation.

16. The IVR system of claim 12 wherein said at least one detail comprises ticket remarks.

17. The IVR system of claim 11 wherein said response is at least one of a preprogrammed response and a recording.

18. The IVR system of claim 11 further comprising means for connecting said contractor and said technician.

19. The IVR system of claim 11 wherein said means for transmitting a notification to said technician further comprises means for transmitting a notification to a plurality of technicians in a predetermined order.

20. The IVR system of claim 11 wherein said work ticket is a dig ticket.
